(19) United States
(12) Patent Application Publication
(10) Pub. No.: US 2025/0271988 A1
(43) Pub. Date: Aug. 28, 2025

(54) MACHINE LEARNING MODEL FOR ACTION GENERATION

(71) Applicant: Clari Inc., Sunnyvale, CA (US)

(72) Inventor: Andrew Elliott, Salt Lake City, UT (US)

(21) Appl. No.: 18/666,724

(22) Filed: May 16, 2024

Related U.S. Application Data
(63) Continuation-in-part of application No. 18/589,499, filed on Feb. 28, 2024.

(51) Int. Cl. G06F 3/04847; G06F 11/34

(52) U.S. Cl. CPC G06F 3/04847; G06F 11/3438; G06F 2201/86

(57) ABSTRACT

A data processing system may display a user interface with one or more controls to indicate one or more records to retrieve from a remote data platform. The system may receive the one or more records of the remote data platform, wherein the one or more records comprises at least a current status. The one or more records are applied (in raw or processed form) as input to a machine learning model to generate, as output, an action that is associated with the one or more records. The machine learning model is configured to generate the action based on a likelihood of changing the current status of the one or more records. The data processing system transmits the action to a user to perform.

### RELATED APPLICATIONS

This patent application is a continuation in part of U.S. patent application Ser. No. 18/589,499 filed on Feb. 28, 2024, which is hereby incorporated by reference in its entirety.

### TECHNICAL FIELD

Embodiments of the present disclosure relate generally to a data processing system and more particularly, embodiments of the disclosure relate to dynamic workflow engine that utilizes a machine learning model to generate an action and one or more conditions.

### BACKGROUND

Data processing systems may include computer readable memory that stores machine executable instructions that can be performed by a processor. The instructions may be grouped together in terms of functionality to what is referred to as an application. Applications may be stored and performed locally at a user's machine, or they may be performed by remotely by a data processing system over a computer network, in what may be referred to as a cloud-based application. Data processing systems on computer networks (e.g., the internet) provide a variety of services to users.

### BRIEF DESCRIPTION OF THE DRAWINGS

Embodiments of the disclosure are illustrated by way of example and not limited to the figures of the accompanying drawings in which like references indicate similar elements.

FIG. 1 illustrates a dynamic workflow engine with a machine learning model that generates an action for a user, in accordance with an embodiment.

FIG. 2 shows an example of a data processing system that includes a dynamic workflow engine integrated with a user interface, in accordance with an embodiment.

FIG. 3 shows an example training cycle of a machine learning model, in accordance with an embodiment.

FIG. 4 illustrates an example method for evaluating a formula from a remote data system, in accordance with an embodiment.

FIG. 5 is a block diagram illustrating an example of a data processing system which may be used with one embodiment.

### DETAILED DESCRIPTION

Computing devices may be accessible over a computer network to provide one or more services. This may be referred to as cloud computing, in which these computing devices provide on-demand access to computing resources over the internet. Such service includes servers, data storage, applications, networking, email, etc. Cloud computing may be available to the public (e.g., public cloud), on a private network (e.g., private cloud), or a hybrid thereof.

Public clouds deliver resources, such as compute, storage, network, develop-and-deploy environments, and applications over the internet. They may be owned and run by third-party cloud service providers. Private clouds are built, run, and used by a single organization, typically located on-premises. They provide greater control, customization, and data security but come with similar costs and resource limitations associated with traditional IT environments. Environments that mix at least one private computing environment (traditional IT infrastructure or private cloud, including edge) with one or more public clouds are called hybrid clouds. They provide resources and services from different computing environments and choose which is suitable for given applications. For cloud deployments, different service frameworks exist. These include, for example, infrastructure as a service (IaaS), platform as a service (PaaS), software as a service (SaaS), and server-less computing.

Cloud computing my include networked servers that store records that are structured to convey opportunity data. Such networked servers may provide coordinated functionality in what may be referred to as a data platform, or more specifically, a customer relationship management (CRM) tool. For example, a data platform may manage one or more records that store information relating to an opportunity (e.g., a target) which may be of interest to a user who wishes to see that opportunity to completion (e.g., to a specified opportunity goal). The information may include various fields that indicate events (e.g., meetings, conferences, etc.), dates, people within a target organization, outreach goals (e.g., emails, meetings, phone conferences, etc.) which help a team manage their outreach and interactions with the target. The data platform may comprise application programming interface (API) for users (e.g., teams) to connect with these records and perform typical operations such as to read from, write to, and search these records. An API or API endpoint may be understood as a computer call from one computer application to another computer application using a pre-defined format (e.g., an API call). Each transmission or receiving of data between computer applications and/or computer devices in the present disclosure may be made through an API call through a computer network protocol (e.g., TCP/IP, etc.).

A data platform (e.g., a CRM tool) may include a plurality of computing devices that manage a party's interactions with customers and potential customers. Data platforms can help the party build customer relationships, improve customer service, increase completion of opportunities, and increase profitability. Data platforms can help manage opportunities, provide actionable insights, and integrate with other platforms.

Even with such a tool, an organization may face challenges with respect to efficiently managing their outreach, tracking interactions, and personalizing their communications in a precise manner. Traditional cloud computing systems (e.g., traditional CRM tools) may not provide the flexibility and functionality for dynamic engagement, which may lead to missed opportunities and inefficiencies. In particular, teams have traditionally struggled with optimizing activities, personalizing communications, and efficiently managing strategies to progress a given opportunity to a desired outcome (e.g., to completion). Computing systems have attempted to address these challenges through CRM systems that offer a degree of automation and data tracking. Existing automation and data tracking solutions typically lack flexibility and lack intelligence to dynamically adapt to the needs of a team for each particular opportunity, resulting in inefficiencies and missed opportunities.

Aspects described relate to computer technology that provides automated generation of actions and associated conditions which may collectively be referred to as a play. Each play may be generated to advance a given opportunity towards completion. A trained machine learning model may be configured to generate an action to be performed (e.g., an email, text message, setting up a meeting, etc.), and one or more conditions associated with the action (e.g., a trigger such as a date, occurrence of an event, an amount of time after an event, etc.). The machine learning model may improve performance and strategic planning by providing real-time, actionable operational and strategic recommendations. Unlike previous solutions, the disclosed system leverages artificial intelligence (AI) to analyze opportunity engagement data comprehensively. This approach enables the generation of a tailored play recommendations that address both immediate activities and overarching strategic goals, significantly improving existing computer solutions that lack such depth and customization.

The disclosed system may include a machine learning model that analyzes both individual and aggregated data to generate a tailored play. The machine learning model may perform natural language processing (NLP) and predictive modeling to analyze records, understand activities associated with an opportunity, identify patterns between stages in these opportunities in view of past actions, and forecast outcomes of each opportunity in view of suggested actions. Unlike traditional systems that may offer static analytics, aspects of the disclosed system may dynamically adapt the machine learning model and its recommended plays, based on ongoing data analysis, thereby improving computer-based insight, customization of computer-based recommendations to a given opportunity, which ultimately enhances the outcome of the opportunity. Such a system improves the technology of a system (e.g., a CRM system) by bridging the gap between insight and actionable strategies in an autonomous manner (e.g., without human intervention and/or human analysis), by leveraging the machine learning model (e.g., an artificial neural network, deep learning, natural language processing, etc.) to infer which actions and conditions are most likely to move a given opportunity towards the end goal. The actions and conditions may be generated by the machine learning model to statistically have the highest likelihood of changing the current status of an opportunity from a first status (e.g., a first opportunity stage) to a second status (e.g., a second opportunity stage that is closer toward the end goal).

In an aspect, a data processing system is configured to perform operations including receiving one or more records of a remote data platform, where the one or more records includes at least a current status, applying, the one or more records as input to a machine learning model to generate, as output, an action and one or more conditions associated with the action, where the action and the one or more conditions are generated based a likelihood of changing the current status of the one or more records, and transmitting the action to a user to perform. In an embodiment, the machine learning model may also be trained to output which user or which role is best suited to perform the action. In an embodiment, the machine learning model includes at least one of: an artificial neural network, a deep learning artificial neural network, or a large language model.

In an embodiment, the data processing system displays a user interface that includes one or more controls for: receiving an indication of the one or more records of the remote data platform, displaying the action, and in response to receiving a confirmation input through the one or more controls, associating the action to the user in a database to assign the action to the user to perform.

In an embodiment, transmitting the action to the user includes detecting device activity of the user, determining whether the action is performed based at least on the device activity of the user, and in response to detecting non-performance of the action in view of the one or more conditions, transmitting the action to the user to perform. For example, the system may detect that when one of the conditions is satisfied (e.g., two weeks after an initial meeting), the action (e.g., scheduling a follow-up meeting) has not been performed.

In an embodiment, the machine learning model is trained based on a plurality of training records that each includes a respective one or more status (which may also be referred to as an opportunity stage), and a plurality of action records that include at least whether a respective action of each of the plurality of action records was performed. In an embodiment, training the machine learning model includes associating features of the plurality of training records with second features of the plurality of action records to generate a plurality of training data, and adjusting weights of the machine learning model by providing the plurality of training data as training input to the machine learning model which configures the machine learning model to generate the action with a highest likelihood of changing the respective one or more status of the plurality of training records.

In an embodiment, training of the machine learning model may be performed autonomously by the data processing system. For example, the data processing system may autonomously detect device activity of the user to detect whether the respective action is performed, detect an impact of the respective action on the current status of the one or more training records, generate an action record based on the device activity and the impact, receive updated to the plurality of training records, update the plurality of training data with the plurality of training records and the plurality of action records, train an updated version of the machine learning model with the updated training data, and deploying the updated version of the machine learning model to the data processing system.

In an embodiment, the input to the machine learning model further includes a current action that is assigned to the user, and transmitting the action to the user includes transmitting a modification of the current action to the user. For example, the machine learning model may consume the input which includes that the current action that is assigned to the user to perform such as, for example, ‘send an email to target with ‘X’ template’, and generate a modification to that action such as ‘send an email to target with ‘Y’ template’, or ‘schedule a meeting with target’.

Other technical features may be readily apparent to one skilled in the art from the following figures, descriptions, and claims.

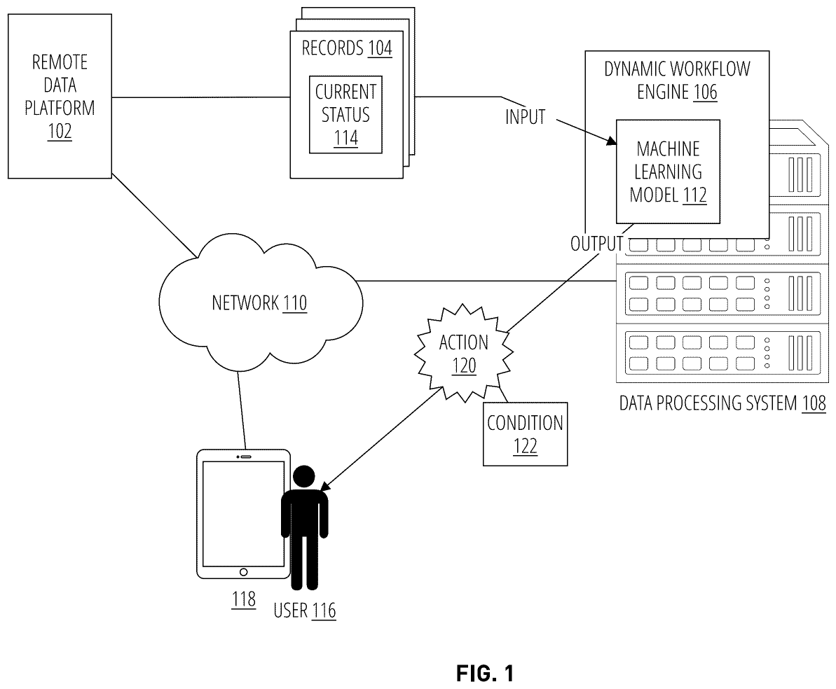

FIG. 1 illustrates a dynamic workflow engine with a machine learning model that generates an action for a user, in accordance with an embodiment.

Data processing system 108 may comprise processing logic which may include hardware (e.g., a processing device, computer-readable memory, transmitter, receiver, power supply, transmission lines, communication buses, etc.) and software (e.g., machine executable instructions stored on computer-readable memory) that is configured to perform the described functionality of dynamic workflow engine 106.

The remote data platform 102 and data processing system 108 may be communicatively coupled to a network 210. Network 210 may represent a plurality of computers in wired or wireless communication with each other using one or more communication protocols (e.g., TCP/IP, Wi-fi, long-term evolution, new radio, etc.). Data processing system 108 may comprise a plurality of computing devices coupled over network 110 that may work together to perform related functionality (e.g., through a distributed computing architecture). Similarly, remote data platform 102 may comprise a plurality of computing devices that store and manage records 104 which may be each be associated with different parties or different opportunities. In an embodiment, remote data platform 102 may comprise a CRM computer system.

Generally, dynamic workflow engine 106 may implement a predictive modeling framework that includes outcome prediction and recommendation logic. Such a dynamic workflow engine 106 may utilize rule-based filtering, machine learning for play ranking, and reinforcement learning to refine the recommendations. In addition, as described in other sections, dynamic workflow engine 106 may implement a feedback loop where user interactions with the recommendations are collected and analyzed to improve, over time, the machine learning model 112 accuracy in generating optimal plays.

The dynamic workflow engine 106 is configured receive one or more records 104 of remote data platform 102. The one or more records 104 includes at least a current status 114. In an example, each record or grouping of records is associated with an opportunity, and the status 114 represents one of multiple stages in the opportunity that may progress the opportunity towards the goal.

The dynamic workflow engine 106 may applying the one or more records 104 (e.g., representing a single opportunity) as input to a machine learning model 114 to generate, as output, an action 120 and one or more conditions 122 associated with the action 120. The action may represent an outreach (e.g., an email, a text message, scheduling a meeting, an invitation, etc.) and the one or more conditions may represent times, events, or combination thereof, that should trigger performance of the action. Together, the action and condition may be referred to as a play or a workflow sensing item, as described in other sections.

The machine learning model 112 is trained to generate the action and the one or more conditions based a likelihood of changing the current status of the one or more records. For example, the machine learning model 112 may comprise an artificial neural network (ANN), a decision tree, a large language model (LLM), a deep learning ANN, or other ML algorithm that is trained to infer which action and which set of conditions has a highest likelihood to advance the current status 114 of the record 104 towards a pre-defined goal or completion. In an embodiment, the machine learning model may also be trained to output which user or which role is best suited to perform the action.

The dynamic workflow engine 106 may transmit the action to a user 116 to perform. For example, user 116 may be associated with a user account associated with dynamic workflow engine 106. This user account may be associated with a token used to authenticate and allow access to the dynamic workflow engine 106 by user 116. The user 116 may access dynamic workflow engine 106 through a computing device 118 which may also be communicatively coupled to network 110. User 116 may be provided with notification (e.g., an email, a text message, a message, etc.) to perform action 120, and one or more triggering conditions 122 associated with when the action 120 is to be performed.

One or more records 104 may include individual representative activity (e.g., actions performed by users) and engagement data from the remote data platform 102. The one or more records 104 may comprises raw data from the database of remote data platform 102, or outcome metrics associated with an opportunity, or a combination thereof. Outcome metrics associated with past opportunities may include completion rates, response times, customer engagement levels, and other metrics. Machine learning model 112 is trained to identify an optimal (highest likelihood of impact) play. This optimal play (the action 120 and one or more conditions 122) may account for opportunities for immediate action improvements, such as follow-up timings and engagement methods, in view of a given opportunity's current activities and interaction history, and may also account for a set of weighted formulas that may emphasize or de-emphasize different activities and conditions in view of past performance.

Machine learning model 112 may, in some cases, modify existing active plays for improved engagement or outcome. For example, records 104 may specify adjustment of an existing play, or suggest an adjustment of a manually entered play, which is determined as having a higher likelihood of impact on progressing the current status 114 of records 104, as described in other sections.

The dynamic workflow engine 106 uses machine learning model 112 to generate actionable insights which are data-backed suggestions for immediate actions, which may include optimal follow-up times and personalized engagement strategies. To run the suggestion model, dynamic workflow engine 106 may perform data collection from various sources such as CRM systems, opportunity activity logs, and performance metrics to generate the one or more records 104.

The dynamic workflow engine 106 may pre-process records 104 to standardize formats and remove data anomalies. The dynamic workflow engine 106 may perform feature engineering to extract meaningful attributes and patterns from the data. Feature engineering may include parsing the records 104 to look for different fields or combinations of fields, re-organizing or tagging fields to a standard pre-defined format, and providing this as input to machine learning model 112. Details are described further in other sections. In an embodiment, users (e.g., operators and action performers) may interact with their play suggestions via a user interface, as described in other sections.

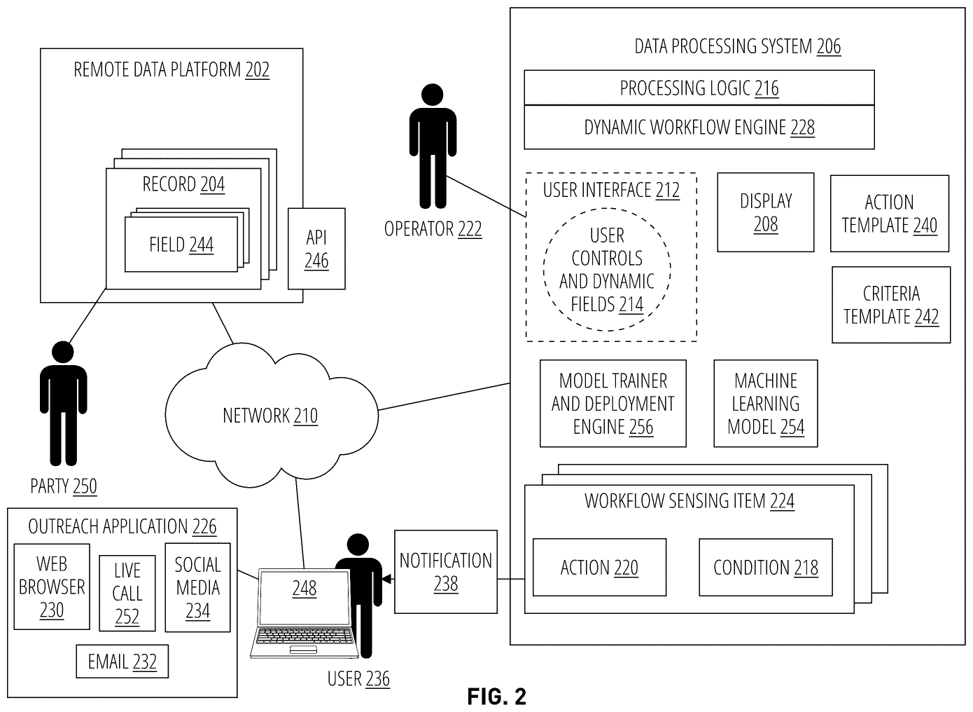

FIG. 2 shows an example of a data processing system that includes a dynamic workflow engine integrated with a user interface, in accordance with an embodiment. Data processing system 206 may comprise a single computing device, or a plurality of computing devices, such as computing device computing device 500.

Data processing system 206 may comprise processing logic 216 which may include hardware (e.g., a processing device, computer-readable memory, transmitter, receiver, power supply, transmission lines, communication buses, etc.) and software (e.g., machine executable instructions stored on computer-readable memory) that is configured to perform the described functionality of dynamic workflow engine 228. Dynamic workflow engine 228 may present a user interface 212 to an operator 222. The user interface 212 may be displayed as a graphical user interface on a display 208. The user interface includes one or more controls (e.g., buttons, input fields, selectable lists, etc.) for identifying one or more records 204 of a remote data platform 202.

The remote data platform 202 and data processing system 206 may be communicatively coupled to a network 210. Network 210 may represent a plurality of computers in wired or wireless communication with each other using one or more communication protocols (e.g., TCP/IP, Wi-fi, long-term evolution, new radio, etc.).

Remote data platform 202 may comprise a plurality of computing devices that store and manage records 204 which may be associated with different parties (e.g., party 250) and store different types of information depending on the underlying body type. In an embodiment, remote data platform 202 may comprise a CRM tool such as, for example, Salesforce or another CRM tool.

The user interface 212 may comprise one or more screens with a button, selectable list, or input field for operator 222 to indicate one or more parties (e.g., one or more customers, potential customers, or accounts of interest). Based on the targeted party 250, data processing system 206 may determine which records on remote data platform 202 are associated with the target (e.g., by querying the remote data platform 202 through an application programming interface API 246).

In an embodiment, presenting the one or more controls 214 comprises presenting selectable fields and/or selectable logical operators to generate the one or more conditions 218. Dynamic workflow engine 228 may generate one or more conditions 218 that are associated with the one or more records 204. For example, dynamic workflow engine 228 may receive input through the one or more user controls and dynamic fields 214 to select which of the one or more fields 244 in the one or more records 204 are to be conditioned upon. Further, dynamic workflow engine 228 may receive input from operator 222 that defines one or more logical operators that are associated with selected fields. For example, operator 222 may input that condition 218 is satisfied “If ‘Field A’ value ≥‘X’ or ‘Field B’ value ≠ ‘Y’”. This condition 218 may be generated and stored in memory as a data object represented by workflow sensing item 224. The one or more conditions 218 may comprise a trigger that may indicate an event (e.g., an email, a meeting, a demonstration, a call, etc.) that starts monitoring or sensing associated with a workflow sensing item 224, an intended close date which may be predicated on the trigger, one or more sentiments or labels associated with an event (e.g., a call or meeting), a deal size or amount, number of contacts, title of the contacts (e.g., chief officer, director, associate, buyer, etc.), email activity, a contractual milestone, etc. In an embodiment, workflow engine 228 may obtain potential conditions from criteria template 242, and present them as options for operator 222 to select one or more conditions 218 through user interface 212.

In an embodiment, receiving the one or more conditions 218 comprises receiving a machine executable script (e.g., with an agreed upon convention or computer language). The script may comprise one or more queries into the one or more records 204, which may leverage calls through API 246.

Dynamic workflow engine 228 may generate an action 220 that is associated with the one or more conditions. This action 220 may comprise an outreach action (e.g., sending an email, a phone call, a video conference call, sending a message on a web-based platform, etc.) to a party 250 that is associated with the one or more records 204. A user may input a definition of action 220 through the user interface 212 that is to be performed. In an example, the dynamic workflow engine 228 may use action template 240 which may comprise a plurality of potential actions that operator 222 wants to make user 236 responsible for performing. Dynamic workflow engine 228 may display a selectable list of actions from the action template 240 through the user interface 212, for operator 222 to select from. Dynamic workflow engine 228 may determine one or more potential actions based on fields of the one or more records or metadata that is associated with the one or more records.

For example, if the record is of type ‘Opportunity’, then dynamic workflow engine 228 may present actions ‘X, Y, and Z’ as potential actions. If the record 204 is of type ‘Account’, then dynamic workflow engine 228 may present actions ‘W and X’. The dynamic workflow engine 228 may dynamically configure the one or more controls 214 to present the selectable actions that tailored for a given record 204 (e.g., based on type, or party 250, or other information). Operator 222 may select from among the available action to generate workflow sensing item 224.

Through the user interface 212, the operator 222 identifies the one or more records 204 and defines the one or more conditions 218 and the action 220 that the dynamic workflow engine 228 saves as a workflow sensing item 224. Workflow sensing item 224 may be referred to as a ‘play’ that defines one or more conditions 218 and at least one action 220 for a user 236 to perform. Each workflow sensing item 224 is related to a party 250 (e.g., a customer or potential customer), and more particularly, to a desired outcome with the party 250, to manage interaction between the user 236 and that party 250. In an aspect, dynamic workflow engine 228 may generate and sense activity related to a plurality of workflow sensing items. For each workflow sensing item, dynamic workflow engine 228 may activate a separate processing thread to perform the sensing and notification associated therein.

In an embodiment, dynamic workflow engine 228 may determine the user 236 that is associated with the action 220. Determining the user 236 (to receive the action) may include searching one or more fields of the one or more records or metadata associated with the one or more records and finding an association of the user to the one or more records. For example, a record may indicate that user 236 attended a meeting or is a point of contact associated with record 204. Each record may correspond to a specific target party (e.g., party 250). Additionally, or alternatively, determining the user comprises receiving indication of the user 236 through the user interface. For example, operator 222 may specify the user 236 that is to receive the action 220. In an example, the dynamic workflow engine 228 may parse metadata associated with record 204 to determine that user 236 is associated with record 204. In an example, dynamic workflow engine 228 may parse the fields of record 204 to select a best candidate to contact party 250 (e.g., user 236 attended a physical or virtual event associated with party 250, or user 236 is a responsible for party 250). Dynamic workflow engine 228 may digitally store user 236 and information associated with that user (e.g., login information, a digital token to contact the user through an application, an email address, a phone number, etc.,) as being associated with workflow sensing item 224. Dynamic workflow engine 228 may use this information to provide the notification 238.

For each workflow sensing item 224, dynamic workflow engine 228 may sense device activity of the respective user 236 (to which the action 220 is to be performed by), and sense the one or more records 204 on the remote data platform. Based on the dynamically updated data of the one or more records 204, dynamic workflow engine 228 may sense whether the one or more conditions 218 are satisfied.

For example, workflow sensing item 224 may be associated with user 236. Dynamic workflow engine 228 may sense the device activity of the user 236 (e.g., ingoing outgoing emails, messages sent by user 236 on third party messaging platforms such as LinkedIn, Sendoso, etc.). Dynamic workflow engine 228 may communicate with one or more application plugins or agents on the user device 248 to detect operations performed by user 236. User device 248 may represent a single device, or a multiple devices operated by user 236. User device 248 may be communicatively coupled to network 210. In an embodiment, dynamic workflow engine 228 may sense operations associated with an email application, browser application, or a standalone application, to determine whether the action is performed by the user (e.g., whether the user has made a phone call, a video call, or has sent an email or other digital message to the party 250). A plugin (e.g., a software agent or secondary functionality) may be built into the email, browser, phone call application, video call application, or standalone application to send user activity to dynamic workflow engine 228 over network 210. In an embodiment, dynamic workflow engine 228 may send regular prompts to user 236 to receive input as to whether or not user 236 has performed one or more actions to determine if action 220 has been performed.

In response to sensing non-performance of the action 220 (e.g., user 236 has not sent an email, phone call, videocall, or other message to party 250), and in response to sensing the one or more records on the remote data platform satisfy the one or more conditions (e.g., ‘Y’ number of days since meeting on Jan. 2, 2022), dynamic workflow engine 228 provides the action 220 as specified in the workflow sensing item 224 to the user 236. This action 220 may be provided through a notification 238 which may be provided as a displayed message (e.g., in a notification window, in an email, etc.,), on a display of user device 248.

User device 248 may include one or more of a desktop computer, a laptop computer, a mobile phone, a tablet computer, a head up display, or other computing device which may correspond to computing device computing device 500. In an embodiment, the one or more conditions 218 comprises multiple conditions. For example, the one or more conditions may include a trigger condition (e.g., event occurred on June 13) to begin sensing the one or more records 204 on the remote data platform. Additionally, the one or more conditions may comprise a time condition to perform the action within (e.g., 14 days from the trigger of when the event occurred).

In an embodiment, providing the action to the user (notification 238) comprises at least one of: displaying a first instruction to the user to send an email to send to a second user; displaying a second instruction to make a phone call to send to the second user; displaying a third instruction to connect with the second user over a social network; displaying a fourth instruction to send a short message service (SMS) message to the second user, or displaying a fifth instruction to send a message to the second user with a third party messaging platform. Additionally, or alternatively, dynamic workflow engine 228 may present a control to the user in the notification 238. The control may comprise a button, a selectable field, etc., which may be integral to outreach application 226 or cause outreach application 226 to run on user device 248. In an example, dynamic workflow engine 228 may perform one or more calls to an operating system of user device 248 to open one of a web browser 230, a calling application 252 (e.g., for voice over IP, a video conference application, etc.) an email application 232, a social media application 234, or other outreach application 226 that may be used to send a message to (or call) party 250. Based on input of this control (e.g., a button press), the dynamic workflow engine 228 may directly call upon a respective outreach application 226 to open on user device 248.

In an embodiment, in response to sensing that the action is performed by the user, the system refrains from providing the action to the user and stores in memory, a second record that includes that the user performed the action prior to satisfaction of the one or more conditions. For example, dynamic workflow engine 228 may sense that user 236 sent an email to party 250 prior to satisfaction of the one or more conditions 218, and in response, store a second record indicating that user 236 sent this email to party 250 without receiving notification 238.

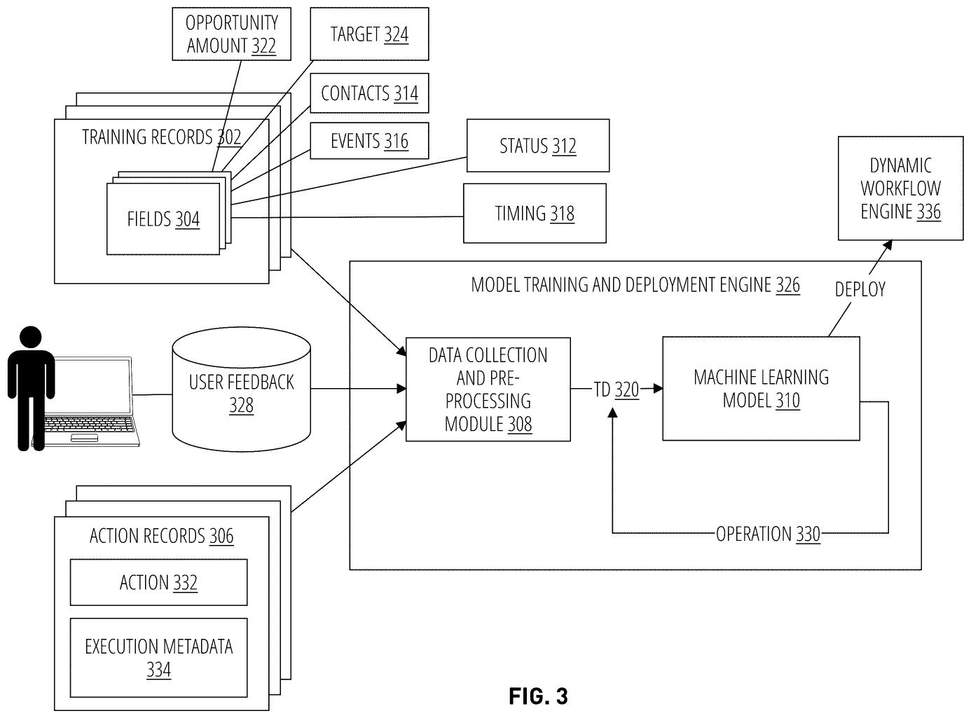

In an embodiment, data processing system 206 may comprise a model trainer and deployment engine 256 that may train and deploy a machine learning model 254. Embodiments of training details are described in other sections, such as, for example, with respect to FIG. 3.

Once the machine learning model 254 is trained and deployed, when data processing system 206 receives one or more records 204 of a remote data platform 202, the system may pre-process these one or more records into a suitable format (e.g., an array of features) as input to the machine learning model 254. The one or more records may include at least a current status (e.g., an opportunity stage) which may be a field 224 of record 204. In another example, even if the current status is not available in the one or more records 204, the system may determine an appropriate current status based on the various other fields 244 stored in the one or more records 204, data processing system 206. For example, if data field A has value ‘X’ and data field Y has value ‘Z’, this may match one of a plurality of predefined data fingerprints. Based on this predefined fingerprint, data processing system 206 may determine that the current status of the one or more records 204 as ‘stage 1’. Machine learning model 254 may be trained to infer the current status based on the fields 244 of the record 204.

Data processing system 206 may apply this pre-processed version of the one or more records 204 as input to machine learning model 254, to generate, as output, an action 220 and one or more conditions 218 that are associated with the action. The action 220 and the one or more conditions 218 are generated based on a likelihood of changing the current status of the one or more records, or more generally, based on a likelihood to progress the opportunity that is associated with record 204 towards completion. The action 220 and condition 218 may be referred to collectively as a workflow sensing item 224 or a play, as described. Once generated, this workflow sensing item 224 may be displayed or otherwise presented to operator 222.

The operator 222 may provide input through user controls and dynamic fields 214 to indicate a confirmation input (e.g., approval) of this workflow sensing item 224. In response, data processing system 206 may assign this workflow sensing item 224 to user 236. In some cases, an indication of the workflow sensing item 224 may be transmitted to user 236 (e.g., through notification 238) immediately upon assignment, or it may be transmitted when in response to when the action 220 is detected as not being performed in view of the condition 218, as described. In other embodiments, the workflow sensing item 224 may be assigned to a user 236 automatically, which may cause automated deployment of computing resources (e.g., one or more agents) to listen for and detect user actions, to detect performance of the action in view of the one or more conditions. These agents may be deployed on the user device or as a cloud based application, or a combination thereof. These agents may operate autonomously to detect user actions, such as by processing network traffic, parsing application logs, or performing API calls to other applications (e.g., email applications, professional or social networking data platforms (e.g., LinkedIn, etc.), messaging applications, calendar applications).

In an embodiment, the machine learning model may also be trained to output which user or which role is best suited to perform the action. For example, training data may include actions assigned to different users, and impact of each based on the different users or roles of the different users. The machine learning model is trained to infer and generate, as output, which role is best suited to perform the action, to have the highest likelihood of impacting the current status of the record (or moving the opportunity towards completion).

Aspects described with respect to FIG. 2 may correspond to a method performed by dynamic workflow engine 228. In some aspects, the operations may be stored as machine-executable instructions and stored in computer-readable memory (e.g., as an application).

FIG. 3 shows an example training cycle of a machine learning model, in accordance with an embodiment.

Generally, model training and deployment engine 326 collects quantitative feedback (training records 302 and action records 306) and qualitative feedback (e.g., user feedback 328). Quantitative feedback may include every user interaction with the recommendation system (e.g., detecting whether or not an activity is performed in view of one or more conditions), including the acceptance rate of recommendations, the completion of suggested actions, and the subsequent impact on respective opportunities. This data provides a rich source for understanding the effectiveness of various plays and strategies. Qualitative feedback includes feedback collected from users of the system, on a per-recommended action basis. This might include insights on why a particular recommended action was particularly effective and/or suggestions for improvement (e.g., a different action or a different condition associated with that action). Qualitative feedback may be captured through surveys, feedback forms embedded within the action, and periodic review sessions.

For example, the model training and deployment engine 326 may train machine learning model 310 based on a plurality of training records 302 that each includes a respective one or more status (which may also be referred to as an opportunity stage), and a plurality of action records 306 that include at least whether a respective action of each of the plurality of action records was performed. Model training and deployment engine 326 may be configured to collect training records 302 which may correspond to one or more records (e.g., 104, 204) stored and made available by a remote data platform (e.g., 102 or 202). Model training and deployment engine 326 may also collect user feedback 328, which may be stored in a database, and action records 306 which may be generated based on past detected actions. For example, each workflow sensing item 224 may comprise one or more tasks to generate and store action records 306 in response to detecting performance of an action or non-performance of an action in view of the corresponding condition. Each action record 306 may comprise an action 332 that was assigned and/or transmitted to a user, and execution metadata 334 such as whether or not an action was performed, when an action was performed, timing each detected action with respect to one or more conditions associated with a given action of that action record, who performed the action, or other detected activity of the user in view of the provided action.

Each training record 302 may comprise a plurality of fields 304 such as, for example, an opportunity amount 322, a target 324 (e.g., target customer), one or more contacts 314, one or more events 316, a status 312, and timing 318 which may comprise time stamps associated with each of the other fields (e.g., a time of an events 316, a time when the status 312 changed last, etc.,). Status 312 may comprise a current status as well as previous statuses of the training record 302, and timing 318 may include timestamps for each status transaction. Each status may represent an opportunity stage, and each training record 302 may represent a particular opportunity. These status 312 and timing 318 represent a progression of a particular opportunity through different stages toward a goal or completion of the opportunity.

Data collection and pre-processing module 308 may perform analysis and integration of the qualitative and quantitative data. Data collection and pre-processing module 308 may aggregate training records 302 and action records 306, and analyze respective fields of the aggregated data to identify patterns between the aggregated fields, such as which types of actions tend to be most successful across different opportunities in view of the different scenarios and stages, or how engagement levels impact the likelihood of seeing an opportunity to completion.

Data collection and pre-processing module 308 may subject the qualitative feedback (user feedback 328) to sentiment analysis and thematic categorization. This helps in identifying common sentiments or themes that might indicate areas for improvement or highlight particularly effective strategies.

Data collection and pre-processing module 308 may perform correlation analysis between the types of recommendations given, the feedback received, and the outcomes achieved. This analysis helps to identify which elements of the recommendations are most strongly correlated with positive outcomes.

Data collection and pre-processing module 308 may associate features of the plurality of training records 302 with second features of the plurality of action records 306 to generate a plurality of training data 320.

To effectively measure the success of each play, data collection and pre-processing module 308 may determine metrics that capture the quality of engagement and the potential impact of specific actions (such as sending an email, scheduling a meeting, which digital platform to reach out to a contact, etc.) based on fields 304 of each record, and how different actions move the status 312 of a given opportunity towards completion. Other field values such as opportunity amount 322, target 324, contacts 314, and events 316 may be factored to generate the metrics and overall impact of these fields to changing of status 312. Data collection and pre-processing module 308 may analyze each of training record 302 and associate corresponding action records 306 and user feedback 328 to effectively align these different records and better determine metrics that measure how likely different actions are to change status 312 in view of the different factors (e.g., other fields 304).

The resulting training data 320 may include aligned data and/or various metrics that may then be formatted to an ingestible and set format (e.g., in the form of a training vector). The training data 320 may comprise weighted features specific to each data set, which may emphasize or de-emphasize different fields 304 actions 332, execution metadata 334, or particular combinations thereof. Features (data fields or combinations thereof) which are associated with progressing an opportunity towards completion in a shorter duration may be emphasized, while features associated with no progress or progressing over a longer duration may be de-emphasized. These metrics generally indicate which action and one or more conditions is most effective in progressing a particular opportunity towards completion. Weightings may be determined based on a scale from 0.1 (low impact) to 1.0 (high impact) based on the significance of each input towards completing an opportunity, which may be indicated through progressing status 312 in a shorter time than any other action. Adjustments may also made in response to external changes, such as new product launches or shifts in market dynamics, ensuring the model's recommendations remain relevant and effective.

Table 1 below shows an example of metrics input categories and specific inputs (and corresponding weights) that may be generated by data collection and pre-processing module 308, which may be used to structure training data 320. The table is meant as an example, and other values and category types may be used.

| INPUT | SPECIFIC | | |
|---|---|---|---|
| CATEGORY | INPUTS | WEIGHTS | PURPOSE |
| Opportunity | Calls Made, | 0.2 | Measures direct |
| Activity Data | Emails Sent, | | engagement efforts |
| | Meetings Held | | and frequency of |
| | | | interactions. |
| Opportunity | Conversion Rates | 0.3 | Assesses the |
| Performance | by Play Usage, | | effectiveness of |
| | Stage Durations | | specific actions and |
| | vs. Benchmarks | | progress against |
| | | | typical opportunity |
| | | | cycle lengths. |
| Historical | Play Success | 0.25 | Evaluates past |
| Performance Data | Rates by Type | | successes to predict |
| | and User/Role | | future performance. |
| Channel | Channel-Specific | 0.15 | Identifies the most |
| Performance | Engagement and | | effective |
| | Success Rates | | communication |
| | | | channels for |
| | | | engagement. |
| Utilization of | Actions | 0.1 | Gauges activity and |
| Recommendation | Completed vs. | | potential for |
| | Assigned per Rep | | efficiency |
| | | | improvements. |

During training, evaluation, tuning operation 330, the training data 320 is provided as input to the machine learning model 310 to adjust weights of the machine learning model. This configures the machine learning model 310 to generate the action with the highest likelihood of changing the respective one or more status (e.g., 312) of the plurality of training records. Model training and deployment engine 326 may perform training, evaluation, tuning operation 330 of model training and deployment engine 326 to adjust internal weights of machine learning model 310. This operation may include using the weighted metrics to train an output play of the machine learning model 310 to provide a highest impact score for each opportunity, in view of the weighted metrics. Training, evaluation, tuning operation 330 may use an optimization algorithm to determine optimal internal weights of machine learning model 310 which generate an optimal action and condition in view of a given input training data 320.

The model training and deployment engine 326 may determine and adjust weightings and formulas to keep the machine learning model 310 adaptive, accurate, and aligned with the evolving dynamics of engagements and outcomes. This process involves several operations that may be undertaken by model training and deployment engine 326 in a continuous cycle of improvement:

To obtain an initial determination of weightings, data collection and pre-processing module 308 may perform historical data analysis. Initially, weightings are determined based on a comprehensive analysis of historical data. This involves identifying patterns and correlations between various inputs (e.g., training records 302, action records 306) which, when taken together, may indicate success of previous plays in view of different fields 304 and/or other factors. Data collection and pre-processing module 308 processes user feedback 328 which may include insights from users (e.g., experienced managers and representatives), so that weights reflect practical wisdom and intuition. Early versions of a machine learning model 310 may be deployed in controlled environment. The performance of these models provides initial feedback on the effectiveness of the weightings.

Model training and deployment engine 326 may adjust weightings over time. As the model 310 is used in the field, each play recommendation and its outcome are tracked and may be stored as action records 306. This includes whether a recommended action led to an opportunity advancing or closing, and how quickly these changes occurred. Using machine learning algorithms, the model analyzes accumulated data to identify which inputs have the most significant impact on outcomes. During training, evaluation, tuning operation 330, weightings of the machine learning model 310 are adjusted to amplify the influence of these high-impact inputs. The model is designed for continuous learning, and routinely incorporates recent data to refine its predictions and recommendations. This ensures the model stays current with market trends, product changes, and shifts in customer behavior.

At training, evaluation, tuning operation 330, model training and deployment engine 326 may train and refine the machine learning model 310. The operation adjusts internal weights of machine learning model 310, where the values of these weights are adjusted to characterize the insights derived from analysis of the qualitative and quantitative data. For example, if the training data 320 indicates that email engagement significantly impacts the success of follow-up plays, the weighting associated with email engagement metrics might be increased. Qualitative feedback can reveal new factors that influence opportunity success but are not currently accounted for in the model. When such factors are identified, model training and deployment engine 326 may quantify these new factors and integrate these factors into training data 320, and train the machine learning model 310 account for these factors in its internal weights. Beyond adjusting weightings and adding new variables, the underlying machine learning algorithms within machine learning model 310 may be updated or tuned to improve their predictive accuracy, based on the latest data and feedback. The collection of recommended plays (e.g., an action and one or more conditions) is dynamically updated, with underperforming plays being revised or removed, and new plays introduced based on emerging best practices and feedback insights. Training, evaluation, tuning operation 330 may be repeated at a periodic interval, or in response to an event (e.g., an influx of new records 302, 306), or both.

In an embodiment, training of the machine learning model may be performed autonomously (e.g., without human interaction or human insight), by model training and deployment engine 326. For example, the data processing system may autonomously detect device activity of the user to detect whether the respective action is performed and store them as action records 306. The data processing system may detect an impact of the respective action on the current status of the one or more training records 302, and generate an action record based on the device activity and the impact. Model training and deployment engine 326 may receive updates to the plurality of training records 302 and update the plurality of training data 320 with the plurality of training records 302 and the plurality of action records 306. Model training and deployment engine 326 may train an updated version of the machine learning model 310 with the updated training data 320. Once trained, 326 may deploy the updated version of the machine learning model to dynamic workflow engine 336, which may be integral to the data processing system (e.g., 108. 206).

Model training and deployment engine 326 may conduct regular A/B tests (e.g., at specified periods or times) to experiment with different weightings, using the current model 310 as the control, and a modified version of the model 310 (with updated weights) as the variant. By comparing the performance of these variations, model training and deployment engine 326 may empirically determine the most effective set of weightings for the training data 320, which in turn may be used to train internal weights of machine learning model 310. User feedback 328 may represent feedback from users (reps and managers) about the relevance, accuracy, and usefulness of each recommended action, for adjusting weightings. This qualitative feedback complements the quantitative data (training records 302, action records 306) and provides a holistic view of the model's performance.

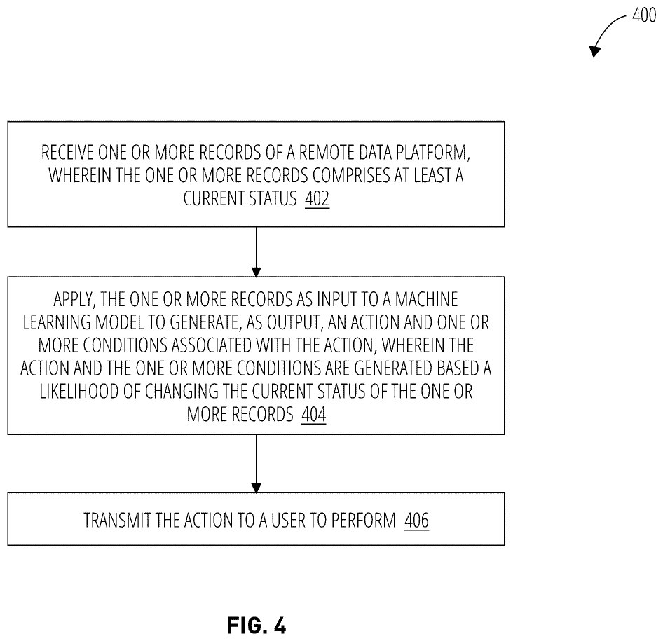

FIG. 4 illustrates an example method 400 for autonomously providing action recommendations with a machine learning model, in accordance with an embodiment. The method may be performed by a dynamic workflow engine that is carried out by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

Method 400 illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in method 400 may be performed in an order different than presented, and that not all of the blocks in the method may be performed.

Method 400 as well as other aspects of the present disclosure are automatically performed by processing logic (e.g., without human guidance or intervention), other than when human input is expressly indicated. In an embodiment, method 400 may be performed with respect to a graphical user interface (GUI) that is displayed to a user. A graphical user interface may be displayed on a user interface that includes one or more controls (e.g., buttons, drop down menus, text input fields, other controls, or a combination thereof) for receiving an indication of the one or more records of the remote data platform. In response to receiving input that identifies the one or more records of the remote data platform, the method may transmit a request to the remote data platform to obtain the one or more records.

At block 402, method 400 receives one or more records of a remote data platform, wherein the one or more records comprises at least a current status. As described, the current status may be an opportunity stage. A sequence of opportunity stages may be one of a pre-defined enumerated set of stages (e.g., stage 1, stage 2, stage 3, stage 4, and so on), where each stage progressively gets closer to completion of the opportunity, and the last stage may represent completion of the opportunity. Each record may have a respective current status.

At block 404, method 400 applies the one or more records as input to a machine learning model to generate, as output, an action and one or more conditions associated with the action, wherein the action and the one or more conditions are generated based a likelihood of changing the current status of the one or more records. More generally, the machine learning model is trained to generate a play as being the most likely to move the associated opportunity towards completion. This may include factors such as which action is most likely to be performed, which action (if performed) is most likely to move the opportunity forward in stage, and/or in a shortest predicted time duration. The one or more records input to the machine learning model may be a pre-processed version of the one or more records, with one or more features extracted and formatted (e.g., as a feature vector or other data array) for input to the machine learning model.

At block 406, method 400 transmits the action to a user to perform. This action may be transmitted upon generation and assignment of the action to the user, or based on detecting non-performance of the action when one or more conditions associated with the action are satisfied, or both. Additionally, or alternatively, at block 406, the method may assign the action to the user by storing the action and the one or more conditions in a database and associating this workflow sensing item (the action and the one or more conditions) to the user in the database. Generation of a workflow sensing item may comprise allocating and dedicating compute resources (e.g., a computer thread, timer, etc.) to periodically run and check whether the action is performed in view of the one or more conditions.

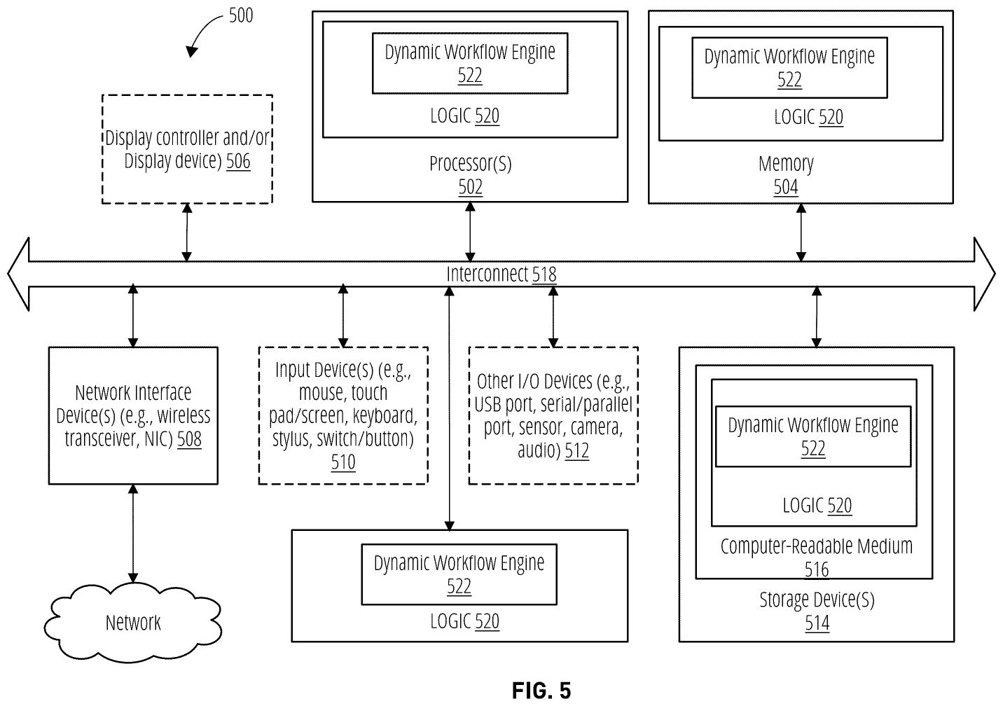

FIG. 5 is a block diagram illustrating an example of a data processing system which may be used with one embodiment. For example, system 500 may represent any of data processing systems described above performing any of the processes or methods described above, such as, for example, data processing system 108, data processing system 206, remote data platform 202, and/or a user device 248.

System 500 can include various different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 502, memory 504, and additional components 508, 510, 512, 514, and 520 which may be coupled over a bus or an interconnect 518. Processor 502 may represent a single processor or multiple processors with a single processor core or multiple processor cores included therein. Processor 502 may represent one or more general-purpose processors such as a microprocessor, a central processing unit (CPU), or the like. More particularly, processor 502 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 502 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 502, which may be a low power multi-core processor socket such as an ultra-low voltage processor, may act as a main processing unit and central hub for communication with the various components of the system. Such processor can be implemented as a system on chip (SoC). Processor 502 is configured to execute instructions for performing the operations and steps discussed herein. System 500 may further include a graphics interface that communicates with controller 506, which may include a display controller, a graphics processor, and/or a display device (e.g., an electronic display, a head up display, etc.).

Processor 502 may communicate with memory 504, which in one embodiment can be implemented via multiple memory devices to provide for a given amount of system memory. Memory 504 may include one or more volatile storage (or memory) devices such as random access memory (RAM), dynamic RAM (DRAM), synchronous DRAM (SDRAM), static RAM (SRAM), or other types of storage devices. Memory 606 may store information including sequences of instructions that are executed by processor 502, or any other device. For example, executable code and/or data of a variety of operating systems, device drivers, firmware (e.g., input output basic system or BIOS), and/or applications can be loaded in memory 606 and executed by processor 502. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as, for example, network interface device(s) 508, optional input device(s) 510, and other optional IO device(s) 512. Network interface device 508 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 510 may include a mouse, a touch pad, a touch sensitive screen (which may be integrated with display device 506), a pointer device such as a stylus, and/or a keyboard (e.g., physical keyboard or a virtual keyboard displayed as part of a touch sensitive screen). For example, input device 612 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 510 may include an audio device. An audio device may include a speaker and/or a microphone to facilitate voice-enabled functions, such as voice recognition, voice replication, digital recording, and/or telephony functions. Other IO devices 512 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 512 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 518 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 502. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor(s) 502, e.g., via a serial peripheral interface (SPI). This flash device may provide for non-volatile storage of system software, including a basic input/output software (BIOS) as well as other firmware of the system.

Storage device 514 may include computer-accessible storage medium 516 (also known as a machine-readable storage medium or a computer-readable medium) on which is stored one or more sets of instructions or software (e.g., module, unit, and/or logic 520) embodying any one or more of the methodologies or functions described herein. Module/unit/logic 520 may also reside, completely or at least partially, within memory 504 and/or within processor 502 during execution thereof by data processing system 500, memory 504 and processor 502 also constituting machine-accessible storage media. Module/unit/logic 520 may further be transmitted or received over a network via network interface device 508.

Computer-readable storage medium 516 may also be used to store some software functionalities described above persistently. While computer-readable storage medium 516 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Module/unit/logic 520, components and other features described herein can be implemented as discrete hardware components or integrated in the functionality of hardware components such as ASICS, FPGAs, DSPs or similar devices. In addition, module/unit/logic 520 can be implemented as firmware or functional circuitry within hardware devices. Further, module/unit/logic 520 can be implemented in any combination hardware devices and software components.

Logic 520 may include dynamic workflow engine 522. Source formula engine 522 may perform the operations described, such as the method of 400 or corresponding to that of dynamic workflow engine 228.

Note that while system 500 is illustrated with various components of a data processing system, it is not intended to represent any particular architecture or manner of interconnecting the components; as such details are not germane to embodiments of the present invention. It will also be appreciated that network computers, handheld computers, mobile phones, servers, and/or other data processing systems which have fewer components, or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A method performed by a data processing system, comprising:
displaying a user interface that includes one or more controls for receiving an indication of the one or more records of the remote data platform;
in response to receiving input that identifies the one or more records of the remote data platform, transmitting a request to the remote data platform to obtain the one or more records;
receiving the one or more records of the remote data platform, wherein the one or more records comprises at least a current status;
applying, the one or more records as input to a machine learning model to generate, as output, an action and one or more conditions associated with the action, wherein the action and the one or more conditions are generated based a likelihood of changing the current status of the one or more records; and
transmitting the action to a user to perform.

2. The method of claim 1, further comprising:
displaying the action; and
in response to receiving a confirmation input through the one or more controls, associating the action to the user in a database to assign the action to the user to perform.

3. The method of claim 1, wherein transmitting the action to the user to perform comprises:
detecting device activity of the user;
determining whether the action is performed based at least on the device activity of the user; and
in response to detecting non-performance of the action in view of the one or more conditions, transmitting the action to the user to perform.

4. The method of claim 1, wherein the machine learning model is trained based on a plurality of training records each comprising a respective one or more status, and a plurality of action records comprising at least whether a respective action of each of the plurality of action records was performed.

5. The method of claim 4, wherein training the machine learning model comprises associating features of the plurality of training records with second features of the plurality of action records to generate a plurality of training data, and adjusting weights of the machine learning model by providing the plurality of training data as training input to the machine learning model which configures the machine learning model to generate the action with a highest likelihood of changing the respective one or more status of the plurality of training records.

6. The method of claim 5, wherein training the machine learning model is performed autonomously by the data processing system, including:
detecting device activity of the user to detect whether the respective action is performed;
detecting an impact of the respective action on the current status of the one or more training records;
generating an action record based on the device activity and the impact;
receiving an update to the plurality of training records or the plurality of action records;
updating the plurality of training data with the plurality of training records and the plurality of action records;
training an updated version of the machine learning model with the updated training data; and
deploying the updated version of the machine learning model to the data processing system.

7. The method of claim 1, wherein the input to the machine learning model further comprises a current action that is assigned to the user, and transmitting the action to the user comprises transmitting a modification of the current action to the user.

8. The method of claim 1, wherein the machine learning model comprises at least one of: an artificial neural network, a deep learning artificial neural network, or a large language model.

9. A data processing system comprising:
a processor; and
a memory storing instructions that, when executed by the processor, configure the data processing system to perform operations comprising:
displaying a user interface that includes one or more controls for receiving an indication of the one or more records of the remote data platform;
in response to receiving input that identifies the one or more records of the remote data platform, transmitting a request to the remote data platform to obtain the one or more records;
receiving the one or more records of the remote data platform, wherein the one or more records comprises at least a current status;
applying, the one or more records as input to a machine learning model to generate, as output, an action and one or more conditions associated with the action, wherein the action and the one or more conditions are generated based a likelihood of changing the current status of the one or more records; and
transmitting the action to a user to perform.

10. The method of claim 9, wherein the output further comprises the user that is to perform the action.

11. The method of claim 9, wherein the operations further comprise:
displaying the action; and
in response to receiving a confirmation input through the one or more controls, associating the action to the user in a database to assign the action to the user to perform.

12. The method of claim 9, wherein transmitting the action to the user to perform comprises:
detecting device activity of the user;
determining whether the action is performed based at least on the device activity of the user; and
in response to detecting non-performance of the action in view of the one or more conditions, transmitting the action to the user to perform.

13. The method of claim 9, wherein the machine learning model is trained based on a plurality of training records each comprising a respective one or more status, and a plurality of action records comprising at least whether a respective action of each of the plurality of action records was performed.

14. The method of claim 13, wherein training the machine learning model comprises associating features of the plurality of training records with second features of the plurality of action records to generate a plurality of training data, and adjusting weights of the machine learning model by providing the plurality of training data as training input to the machine learning model which configures the machine learning model to generate the action with a highest likelihood of changing the respective one or more status of the plurality of training records.

15. A non-transitory computer-readable storage medium, the computer-readable storage medium including instructions that when executed by a computer, cause the computer to perform operations comprising:
displaying a user interface that includes one or more controls for receiving an indication of the one or more records of the remote data platform;
in response to receiving input that identifies the one or more records of the remote data platform, transmitting a request to the remote data platform to obtain the one or more records;
receiving the one or more records of the remote data platform, wherein the one or more records comprises at least a current status;
applying, the one or more records as input to a machine learning model to generate, as output, an action and one or more conditions associated with the action, wherein the action and the one or more conditions are generated based a likelihood of changing the current status of the one or more records; and
transmitting the action to a user to perform.

16. The non-transitory computer-readable storage medium of claim 15, wherein the output further comprises the user that is to perform the action.

17. The non-transitory computer-readable storage medium of claim 15, wherein the operations further comprise:
displaying the action; and
in response to receiving a confirmation input through the one or more controls, associating the action to the user in a database to assign the action to the user to perform.

18. The non-transitory computer-readable storage medium of claim 15, wherein transmitting the action to the user to perform comprises:
detecting device activity of the user;
determining whether the action is performed based at least on the device activity of the user; and
in response to detecting non-performance of the action in view of the one or more conditions, transmitting the action to the user to perform.

19. The non-transitory computer-readable storage medium of claim 15, wherein the machine learning model is trained based on a plurality of training records each comprising a respective one or more status, and a plurality of action records comprising at least whether a respective action of each of the plurality of action records was performed.

20. The non-transitory computer-readable storage medium of claim 19, wherein training the machine learning model is performed autonomously by the data processing system, including:
detecting device activity of the user to detect whether the respective action is performed;
detecting an impact of the respective action on the current status of the one or more training records;
generating an action record based on the device activity and the impact;
receiving an update to the plurality of training records or the plurality of action records;
updating the plurality of training data with the plurality of training records and the plurality of action records;
training an updated version of the machine learning model with the updated training data; and
deploying the updated version of the machine learning model to the data processing system.
